(19) United States
(12) Patent Application Publication
(10) Pub. No.: US 2026/0326004 A1
(43) Pub. Date: Oct. 22, 2026

(54) AIR FILTRATION ASSEMBLY

(71) Applicant: Vertiv Corporation, Westerville, OH (US)

(72) Inventors: Akshay D. Shah, Pune (IN); Rahul Bhintade, Pune (IN); Dhiraj Dange, Pune (IN)

(21) Appl. No.: 19/571,001

(22) Filed: Mar. 18, 2026

(30) Foreign Application Priority Data
Apr. 21, 2025 (IN) 202511038143

(51) Int. Cl. B01D 46/00

(52) U.S. Cl. CPC B01D 46/0004; B01D 46/0005; B01D 2279/45

(57) ABSTRACT

The present disclosure relates to an air filtration assembly for electronic equipment. The air filtration assembly includes a fan mesh and a filtration foam. The filtration foam includes a first fastening slot. The fan mesh is configured to be mounted over the filtration foam. The fan mesh includes an interlock mechanism for assembling with the filtration foam to form the air filtration assembly. The fan mesh further includes a second fastening slot axially aligned with the first fastening slot. The assembly is positioned over an air vent of a front fascia of the electronic equipment and the front fascia includes a third fastening slot. The first fastening slot and the second fastening slot may be fastened with the third fastening slot using a fastening mechanism.

### CROSS-REFERENCE TO RELATED APPLICATIONS

The present application claims the benefit of India Provisional Application No. 202511038143 filed on Apr. 21, 2025, which is herein incorporated by reference in the entirety.

### TECHNICAL FIELD

The present disclosure generally relates to an air filtration assembly for electronic equipment, and, more particularly, to an air filtration assembly for rectifier and converter units to prevent the ingress of airborne contaminants in industrial environments.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the present technology.

Electronic equipment such as rectifiers and converters used in industrial and infrastructure installations are typically enclosed within protective housings designed to support continuous and reliable operation. These existing enclosures incorporate cooling arrangements for thermal management, including cooling fans, ventilation openings, and fan meshes positioned on a front or side fascia of the electronic equipment. Ambient air is drawn through such ventilation structures to dissipate heat generated by internal electrical and electronic components. These enclosure-based cooling configurations represent widely adopted and established practices in the design of industrial power electronic systems.

### SUMMARY

This summary is provided to introduce aspects related to an assembly for air filtration, and the aspects are further described below in the detailed description. This summary is not intended to identify essential features of the present subject matter, nor is it intended for use in determining or limiting the scope of the present subject matter.

The present disclosure relates to an air filtration assembly for electronic equipment such as rectifiers and converters. The air filtration assembly may be configured to be mounted on a front fascia of the electronic equipment and includes a filtration foam and a fan mesh assembled together to form a detachable unit. The air filtration assembly may be arranged to be positioned over an air vent of the electronic equipment and secured thereto using a fastening mechanism, thereby enabling integration of the assembly with existing cooling configurations of the electronic equipment.

The air filtration assembly provides effective filtration of airborne contaminants entering through ventilation openings of the electronic equipment while maintaining required airflow for thermal management. The assembly allows ease of installation and removal, supports routine maintenance and replacement, and integrates with existing equipment without requiring structural modification. The configuration contributes to improved operational reliability, reduced maintenance effort, and enhanced service life of the electronic equipment operating in industrial environments.

An air filtration assembly for electronic equipment is disclosed in accordance with one or more illustrative embodiments of the present disclosure. In one illustrative embodiment, the air filtration assembly includes a filtration foam. In another illustrative embodiment, the filtration foam includes a first fastening slot. In another illustrative embodiment, the air filtration assembly includes a fan mesh. In another illustrative embodiment, the fan mesh is arranged to be mounted over the filtration foam. In another illustrative embodiment, the fan mesh includes an interlock mechanism. In another illustrative embodiment, the fan mesh includes a second fastening slot. In another illustrative embodiment, the interlock mechanism is configured to interlock with and couple the filtration foam with the fan mesh to form the air filtration assembly and axially align the first fastening slot with the second fastening slot. In another illustrative embodiment, the air filtration assembly is arranged to be placed over an air vent of a front fascia of the electronic equipment. In another illustrative embodiment, the front fascia includes a third fastening slot. In another illustrative embodiment, the first fastening slot and the second fastening slot are configured to be securely fastened with the third fastening slot using a fastening mechanism.

In a further aspect, the filtration foam may be configured to permit airflow while filtering airborne contaminants including dust, steel burrs, and metallic particles.

In a further aspect, the filtration foam may be made of material selected from a group consisting of Blue 25 PPI Qudra foam, polyurethane foam, polyester foam, melamine foam, open-cell polyethylene foam, reticulated foam, and activated carbon foam.

In a further aspect, the filtration foam may be configured to comply with UL 94 HF-1 flammability standards.

In a further aspect, the fan mesh may be made of a material selected from a group consisting of polycarbonate (PC), acrylonitrile butadiene styrene (ABS), polyamide (nylon), polyethylene terephthalate (PET), polyether ether ketone (PEEK), polytetrafluoroethylene (PTFE), polypropylene (PP), polyvinyl chloride (PVC), thermoplastic polyurethane (TPU), fiberglass-reinforced plastic (FRP) and combinations thereof.

In a further aspect, the fan mesh may include a grid structure configured to provide mechanical support to the filtration foam while allowing airflow.

In a further aspect, the grid structure may be made of a material selected from a group consisting of stainless steel, coated aluminum, and high-strength polymer composites.

In a further aspect, the interlock mechanism may include a snap-fit connector configured to detachably secure the filtration foam to the fan mesh.

In a further aspect, the first fastening slot, the second fastening slot, and the third fastening slot may be axially aligned.

In a further aspect, the electronic equipment may include at least one of a rectifier and a converter.

A system is disclosed in accordance with one or more illustrative embodiments of the present disclosure. In one illustrative embodiment, the system includes electronic equipment. In another illustrative embodiment, the system includes an air filtration assembly configured for the electronic equipment. In another illustrative embodiment, the air filtration assembly includes a filtration foam. In another illustrative embodiment, the filtration foam includes a first fastening slot. In another illustrative embodiment, the air filtration assembly includes a fan mesh. In another illustrative embodiment, the fan mesh is arranged to be mounted over the filtration foam. In another illustrative embodiment, the fan mesh includes an interlock mechanism. In another illustrative embodiment, the fan mesh includes a second fastening slot. In another illustrative embodiment, the interlock mechanism is configured to interlock with and couple the filtration foam with the fan mesh to form the air filtration assembly and axially align the first fastening slot with the second fastening slot. In another illustrative embodiment, the air filtration assembly is arranged to be placed over an air vent of a front fascia of the electronic equipment. In another illustrative embodiment, the front fascia includes a third fastening slot. In another illustrative embodiment, the first fastening slot and the second fastening slot are configured to be securely fastened with the third fastening slot using a fastening mechanism.

In a further aspect, the filtration foam may be configured to permit airflow while filtering airborne contaminants including dust, steel burrs, and metallic particles.

In a further aspect, the filtration foam may be made of material selected from a group consisting of Blue 25 PPI Qudra foam, polyurethane foam, polyester foam, melamine foam, open-cell polyethylene foam, reticulated foam, and activated carbon foam.

In a further aspect, the filtration foam may be configured to comply with UL 94 HF-1 flammability standards.

In a further aspect, the fan mesh may be made of a material selected from a group consisting of polycarbonate (PC), acrylonitrile butadiene styrene (ABS), polyamide (nylon), polyethylene terephthalate (PET), polyether ether ketone (PEEK), polytetrafluoroethylene (PTFE), polypropylene (PP), polyvinyl chloride (PVC), thermoplastic polyurethane (TPU), fiberglass-reinforced plastic (FRP) and combinations thereof.

In a further aspect, the fan mesh may include a grid structure configured to provide mechanical support to the filtration foam while allowing airflow.

In a further aspect, the grid structure may be made of a material selected from a group consisting of stainless steel, coated aluminum, and high-strength polymer composites.

In a further aspect, the interlock mechanism may include a snap-fit connector configured to detachably secure the filtration foam to the fan mesh.

In a further aspect, the first fastening slot, the second fastening slot, and the third fastening slot may be axially aligned.

In a further aspect, the electronic equipment may include at least one of a rectifier and a converter.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a perspective view of an air filtration assembly, in accordance with one or more embodiments of the present disclosure.

FIG. 2 illustrates an exploded view of the air filtration assembly, in accordance with one or more embodiments of the present disclosure.

FIG. 3 illustrates a side view of the air filtration assembly with electronic equipment, in accordance with one or more embodiments of the present disclosure.

FIG. 4 illustrates a perspective view of the air filtration assembly to be mounted with the electronic equipment, in accordance with one or more embodiments of the present disclosure.

FIG. 5 illustrates a front view of the electronic equipment mounted with the air filtration assembly, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

In industrial environments such as steel plants, cement plants, and similar heavy-duty installations, electronic equipment including rectifiers and converters may play an important role in converting and regulating electrical energy for continuous operation of infrastructure systems. Such electronic equipment is typically housed within enclosures provided with cooling arrangements including air vents, fan assemblies, and protective meshes located on a front fascia of the enclosure. These cooling arrangements may be intended to enable airflow for thermal management of internal components during operation, thereby supporting reliability and performance of the electronic equipment.

However, in harsh industrial environments, airborne contaminants such as metallic dust, steel burrs, and fine conductive debris are commonly present in the ambient atmosphere. These contaminants may enter the electronic equipment through ventilation openings and fan meshes and may accumulate on internal electrical circuits, connectors, and components. The presence of such conductive contaminants within the equipment may result in unintended conductive paths, leading to electrical faults, short circuits, operational malfunction, or safety-related hazards. In many cases, such failures require extensive maintenance procedures, including dismantling of the electronic equipment or complete replacement, thereby increasing downtime and maintenance effort.

The present disclosure provides an air filtration assembly configured to address the above-described issues by enabling filtration of airborne contaminants entering through ventilation openings of electronic equipment. In embodiments, the air filtration assembly includes a filtration foam and a fan mesh assembled as a detachable unit configured to be mounted on a front fascia of the electronic equipment over an air vent. In embodiments, the assembly is structured to integrate with existing equipment using a fastening mechanism, thereby facilitating ease of installation, removal, and replacement. In embodiments, the configuration supports effective contaminant filtration while maintaining airflow required for thermal management, thereby improving operational reliability and serviceability of electronic equipment deployed in industrial environments.

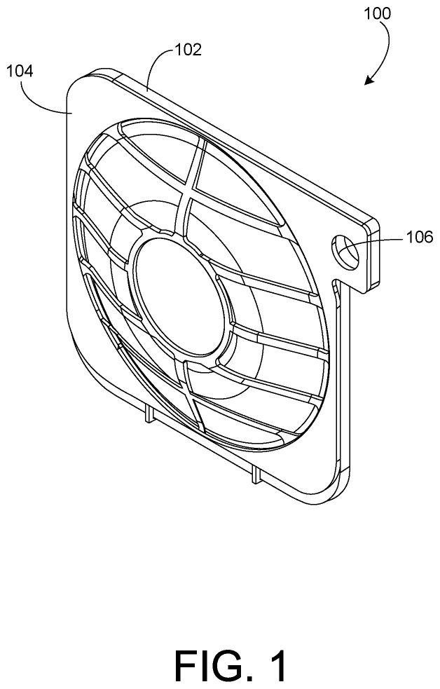

FIG. 1 illustrates a perspective view of an air filtration assembly 100, in accordance with one or more embodiments of the present disclosure. The air filtration assembly 100 may be designed for easy attachment to and detachment from a front fascia of the electronic equipment, such as rectifiers or converters, allowing for convenient installation, servicing, and replacement. In one embodiment, the air filtration assembly 100 is configured as a unitary, front-mountable module adapted to be retrofitted onto existing electronic equipment without requiring any structural modification to the electronic equipment. The air filtration assembly 100 includes a filtration foam 102 and a fan mesh 104.

The filtration foam 102 and the fan mesh 104 may be assembled together to form the air filtration assembly 100. The filtration foam 102 may serve as a primary barrier for capturing airborne contaminants such as dust, steel burrs, and metallic particles, while the fan mesh 104 may provide structural reinforcement and mechanical protection to the filtration foam 102. The fan mesh 104 may further define a protective outer layer configured to prevent accidental contact with the filtration foam 102 and to maintain the positional integrity of the filtration foam 102 during operation. The fan mesh 104 may be positioned over the filtration foam 102 to prevent deformation, displacement, or damage during installation and operation. This integrated assembly may ensure that while clean airflow is maintained into the electronic equipment, the filtration foam 102 remains securely supported and functionally effective over extended periods of use, even in high-vibration or particulate-heavy industrial environments.

The fan mesh 104 and the filtration foam 102 may include at least one fastening slot. The slot of the fan mesh 104 and the filtration foam 102 may align together to form a fastening slot 106. The fastening slot 106 may be adapted to be fastened to the air filtration assembly over the electronic equipment. The air filtration assembly 100 may be fastened using a screw mechanism. The fastening slot 106 may enable accurate positioning of the air filtration assembly 100 relative to an air vent provided on the front fascia of the electronic equipment, thereby ensuring complete coverage of the air entry region.

The fastening elements may be strategically positioned to provide secure mounting while allowing service engineers or operators to quickly remove or replace the assembly when a clogging alarm is triggered or during routine maintenance. Such a removable fastening arrangement may facilitate repeated installation and removal of the air filtration assembly 100 without degradation of the mounting interface. The integrated construction of the air filtration assembly 100 may facilitate retrofitting onto existing systems without requiring modifications to the equipment chassis, significantly reducing downtime and ensuring continued protection against airborne contaminants.

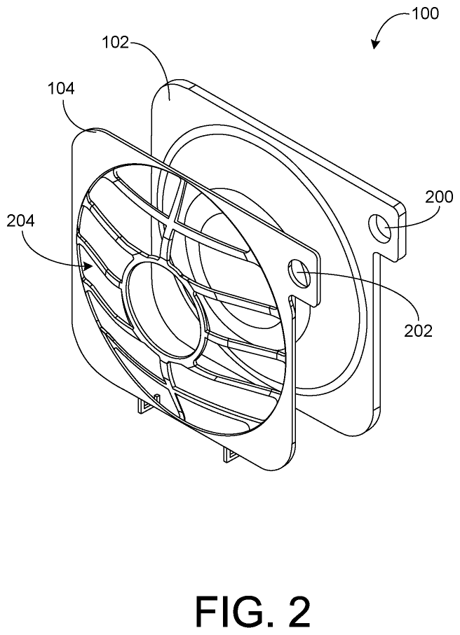

FIG. 2 illustrates an exploded view of the air filtration assembly 100, in accordance with one or more embodiments of the present disclosure. The air filtration assembly 100 may include the filtration foam 102, which may be made of Blue 25 PPI Qudra foam, selected for its balance between airflow and particulate filtration, as well as its UL 94 HF-1 flame-retardant rating. This material may ensure reliable performance in industrial environments where both contaminant control and fire safety are essential. As shown in exploded configuration, the filtration foam 102 may be arranged to be positioned adjacent to the fan mesh 104 such that incoming air is required to pass through the filtration foam 102 prior to entering the electronic equipment. In different implementations, based on environmental or application-specific requirements, the filtration foam 102 may be made of other materials, such as polyurethane foam, polyester foam, melamine foam, open-cell polyethylene foam, reticulated foam, activated carbon foam, or combinations thereof. These materials may be selected to address specific needs, including chemical resistance, moisture repellency, thermal insulation, or enhanced particle retention.

The filtration foam 102 may include a first fastening slot 200. The first fastening slot 200 may be positioned at a corner of the filtration foam 102 to fasten the filtration foam 102 with the fan mesh 104 and the electronic equipment. The first fastening slot 200 may be configured to facilitate accurate positioning and secure retention of the filtration foam 102 relative to the fan mesh 104 during assembly. The fan mesh 104 may include a second fastening slot 202. The second fastening slot 202 may be positioned at a corner of the fan mesh 104, axially aligning with the first fastening slot 200 to fasten the fan mesh 104 with the filtration foam 102 to attach with the electronic equipment. The axial alignment of the first fastening slot 200 and the second fastening slot 202 may enable a common fastening mechanism to pass therethrough for securing the air filtration assembly 100 as a single unit.

The fan mesh 104 may be made of polycarbonate (PC), selected for its impact resistance, thermal stability, and electrical insulation properties, making it suitable for use in industrial environments where protection from conductive contaminants is required. In different embodiments, depending on design and performance requirements, the fan mesh 104 may be made of other nonconductive materials such as acrylonitrile butadiene styrene (ABS), polyamide (nylon), polyethylene terephthalate (PET), polyether ether ketone (PEEK), polytetrafluoroethylene (PTFE), polypropylene (PP), polyvinyl chloride (PVC), thermoplastic polyurethane (TPU), fiberglass-reinforced plastic (FRP), and other thermoplastic or thermosetting polymers.

The selection of material for the fan mesh 104 may contribute to maintaining electrical insulation and mechanical integrity of the air filtration assembly 100 during prolonged operation in industrial environments. These materials may offer varying degrees of mechanical strength, chemical resistance, and thermal endurance, enabling the air filtration assembly to function effectively in diverse industrial applications.

The fan mesh 104 may further include a grid structure 204 to maintain the airflow into the electronic equipment while simultaneously providing mechanical support to the filtration foam 102. The grid structure 204 may include a plurality of intersecting horizontal and vertical bars forming a rigid or semi-rigid lattice designed to prevent the filtration foam 102 from sagging, deforming, or becoming dislodged during operation. The grid structure 204 may be configured to distribute airflow uniformly across the filtration foam 102 while preserving the structural stability of the air filtration assembly 100.

The structural arrangement of the grid may allow air to pass through with minimal resistance while also acting as a protective barrier against accidental contact, foreign objects, or vibration-induced damage. In some embodiments, the grid structure 204 may be fabricated from materials such as stainless steel, coated aluminum, or high-strength polymer composites, depending on the desired balance between durability, weight, and corrosion resistance. The integration of the grid structure 204 with the fan mesh 104 may ensure that the air filtration assembly retains its shape and functionality throughout its operational lifespan, even in high-dust or high-temperature industrial environments.

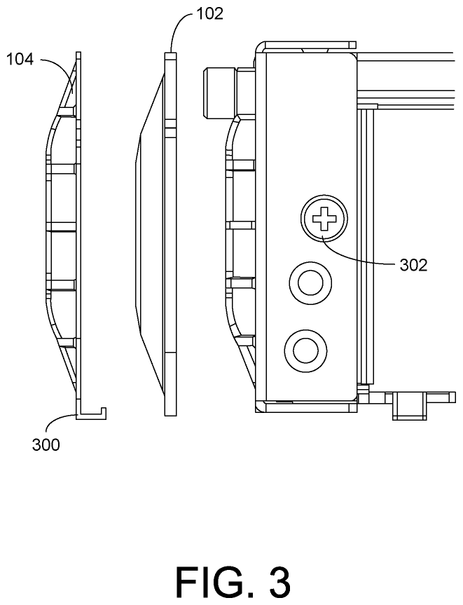

FIG. 3 illustrates a side view of the filtration foam 102, and the fan mesh 104 with electronic equipment 302, in accordance with one or more embodiments of the present disclosure.

In embodiments, a system may include the electronic equipment 302 in addition to the filtration foam 102, and the fan mesh 104.

The fan mesh 104 may be positioned over the filtration foam 102, where the fan mesh 104 may include an interlock mechanism 300 configured to securely engage with the filtration foam 102. As illustrated, the filtration foam 102 and the fan mesh 104 may be arranged in an overlapping configuration along a common mounting axis relative to the front fascia 402 of the electronic equipment 302. The interlock mechanism 300 may include a snap-fit connector that correspondingly aligns with complementary features on the filtration foam 102. The interlock mechanism 300 may be defined to form the air filtration assembly 100 by interlocking the filtration foam 102 with the fan mesh 104. The snap-fit engagement enables tool-free coupling between the filtration foam 102 and the fan mesh 104 during assembly. The interlock mechanism 300 may be designed to maintain a reliable connection between the fan mesh 104 and the filtration foam 102, preventing displacement or detachment during installation, operation, or maintenance.

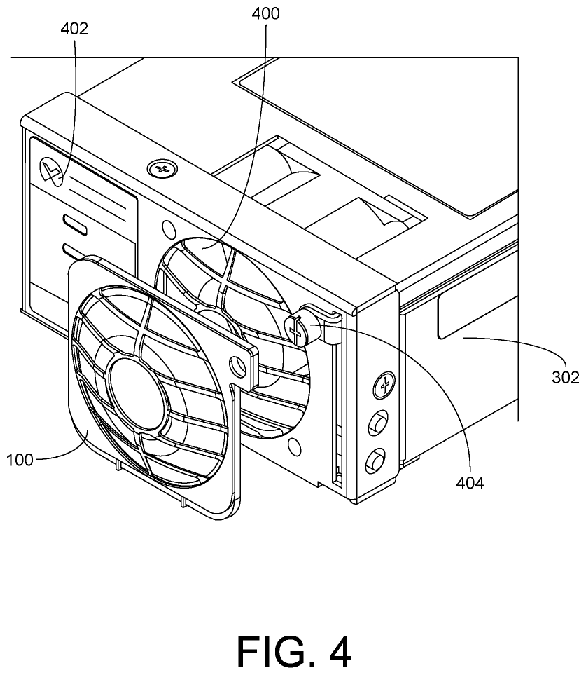

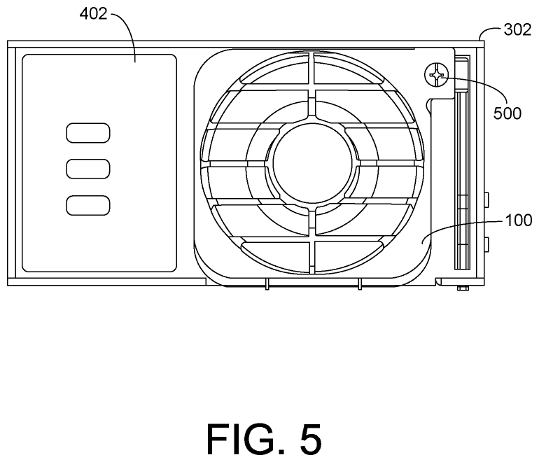

In embodiments, when the air filtration assembly 100 is formed and arranged to be placed over an air vent 400 of the front fascia 402 of the electronic equipment 302 (as shown in FIG. 4), the air filtration assembly 100 may be attached to the electronic equipment 302 through a fastening mechanism 500 (as shown in FIG. 5). The front fascia 402 of the electronic equipment 302 may include a third fastening slot 404. The third fastening slot 404 may be defined on the front fascia 402 to fasten the air filtration assembly 100 with the electronic equipment 302 via the fastening mechanism 500. The fastening mechanism 500 may correspond to, or include, a screw mechanism (e.g., a Phillips screw).

The fastening mechanism 500 may extend through the aligned fastening slots to secure the air filtration assembly 100 in a fixed position over the air vent 400. The first fastening slot 200, the second fastening slot 202, and the third fastening slot 404 may be axially aligned with each other and fastened with the fastening mechanism 500 to attach the air filtration assembly 100 with the electronic equipment 302. This axial alignment facilitates straightforward installation and removal of the air filtration assembly 100 during maintenance or replacement operations without disturbing internal components of the electronic equipment 302.

FIG. 5 illustrates a front view of the electronic equipment 302 mounted with the air filtration assembly 100, in accordance with one or more embodiments of the present disclosure. The air filtration assembly 100 may have a predetermined time range for replacement of the filtration foam 102, which may be set, and an alarm may be raised to the service provider. Upon receiving the alarm, the service provider may unfasten the air filtration assembly 100, conduct an inspection of the filtration foam 102 for its remaining useful life, and choose to replace the filtration foam 102 with a new filtration foam and re-fasten the air filtration assembly 100 with the electronic equipment 302.

The air filtration assembly 100 of the present disclosure may provide significant technical advancement and economic significance. Firstly, the present disclosure provides the air filtration assembly, which forms a modular and unified assembly that is easy to install and replace without altering existing electronic enclosures. Further, embodiments may provide a single-shot fastening alignment system that ensures secure attachment to a front fascia of electronic equipment, enhancing structural stability and filtration efficiency. Further, the air filtration assembly of the present disclosure may enhance operational reliability by preventing conductive contaminants from entering electronic equipment, significantly reducing the risk of electrical failures and associated maintenance costs in industrial environments.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried out in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. An air filtration assembly for electronic equipment, the air filtration assembly comprising:
a filtration foam comprising a first fastening slot; and
a fan mesh arranged to be mounted over the filtration foam, wherein the fan mesh comprises:
an interlock mechanism; and
a second fastening slot, wherein the interlock mechanism is configured to interlock with and couple the filtration foam with the fan mesh to form the air filtration assembly and axially align the first fastening slot with the second fastening slot,
wherein the air filtration assembly is arranged to be placed over an air vent of a front fascia of the electronic equipment, the front fascia comprising a third fastening slot, wherein the first fastening slot and the second fastening slot are configured to be securely fastened with the third fastening slot using a fastening mechanism.

2. The air filtration assembly of claim 1, wherein the filtration foam is configured to permit airflow while filtering airborne contaminants comprising dust, steel burrs, and metallic particles.

3. The air filtration assembly of claim 1, wherein the filtration foam is made of material selected from a group consisting of Blue 25 PPI Qudra foam, polyurethane foam, polyester foam, melamine foam, open-cell polyethylene foam, reticulated foam, and activated carbon foam.

4. The air filtration assembly of claim 1, wherein the filtration foam is configured to comply with UL 94 HF-1 flammability standards.

5. The air filtration assembly of claim 1, wherein the fan mesh is made of a material selected from a group consisting of polycarbonate (PC), acrylonitrile butadiene styrene (ABS), polyamide (nylon), polyethylene terephthalate (PET), polyether ether ketone (PEEK), polytetrafluoroethylene (PTFE), polypropylene (PP), polyvinyl chloride (PVC), thermoplastic polyurethane (TPU), fiberglass-reinforced plastic (FRP) and combinations thereof.

6. The air filtration assembly of claim 5, wherein the fan mesh includes a grid structure configured to provide mechanical support to the filtration foam while allowing airflow.

7. The air filtration assembly of claim 6, wherein the grid structure is made of a material selected from a group consisting of stainless steel, coated aluminum, and high-strength polymer composites.

8. The air filtration assembly of claim 1, wherein the interlock mechanism comprises a snap-fit connector configured to detachably secure the filtration foam to the fan mesh.

9. The air filtration assembly of claim 1, wherein the first fastening slot, the second fastening slot, and the third fastening slot are axially aligned.

10. The air filtration assembly of claim 1, wherein the electronic equipment comprises at least one of a rectifier and a converter.

11. A system comprising:
electronic equipment; and
an air filtration assembly configured for the electronic equipment, the air filtration assembly comprising:
a filtration foam comprising a first fastening slot; and
a fan mesh arranged to be mounted over the filtration foam, wherein the fan mesh comprises:
an interlock mechanism; and
a second fastening slot, wherein the interlock mechanism is configured to interlock with and couple the filtration foam with the fan mesh to form the air filtration assembly and axially align the first fastening slot with the second fastening slot,
wherein the air filtration assembly is arranged to be placed over an air vent of a front fascia of the electronic equipment, the front fascia comprising a third fastening slot, wherein the first fastening slot and the second fastening slot are configured to be securely fastened with the third fastening slot using a fastening mechanism.

12. The system of claim 11, wherein the filtration foam is configured to permit airflow while filtering airborne contaminants comprising dust, steel burrs, and metallic particles.

13. The system of claim 11, wherein the filtration foam is made of material selected from a group consisting of Blue 25 PPI Qudra foam, polyurethane foam, polyester foam, melamine foam, open-cell polyethylene foam, reticulated foam, and activated carbon foam.

14. The system of claim 11, wherein the filtration foam is configured to comply with UL 94 HF-1 flammability standards.

15. The system of claim 11, wherein the fan mesh is made of a material selected from a group consisting of polycarbonate (PC), acrylonitrile butadiene styrene (ABS), polyamide (nylon), polyethylene terephthalate (PET), polyether ether ketone (PEEK), polytetrafluoroethylene (PTFE), polypropylene (PP), polyvinyl chloride (PVC), thermoplastic polyurethane (TPU), fiberglass-reinforced plastic (FRP) and combinations thereof.

16. The system of claim 15, wherein the fan mesh includes a grid structure configured to provide mechanical support to the filtration foam while allowing airflow.

17. The system of claim 16, wherein the grid structure is made of a material selected from a group consisting of stainless steel, coated aluminum, and high-strength polymer composites.

18. The system of claim 11, wherein the interlock mechanism comprises a snap-fit connector configured to detachably secure the filtration foam to the fan mesh.

19. The system of claim 11, wherein the first fastening slot, the second fastening slot, and the third fastening slot are axially aligned.

20. The system of claim 11, wherein the electronic equipment comprises at least one of a rectifier and a converter.
